(19) United States
(12) Patent Application Publication
(10) Pub. No.: US 2005/0095502 A1
(43) Pub. Date: May 5, 2005

(54) Sealed battery

(75) Inventors: Naoto Sugimune, Osaka (JP); Yoshiki Somatomo, Osaka (JP); Toshiya Takaishi, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Osaka (JP)

(21) Appl. No.: 10/954,178

(22) Filed: Oct. 1, 2004

(30) Foreign Application Priority Data
Oct. 3, 2003 (JP) P2003-345564
Jul. 2, 2004 (JP) P2004-196849

(51) Int. Cl. H01M 2/06; H01M 2/08

(52) U.S. Cl. 429/180; 429/181; 429/161

(57) ABSTRACT

A sealed battery capable of increasing the battery capacity while ensuring high sealing properties can be obtained. The sealed battery comprises, a battery case 1, a lid 7 for closing the opening top face of the battery case 1, a terminal mounting hole 13 in the lid 7, and a negative terminal 11 engaging with the terminal mounting hole 13 via an insulating packing 9. The negative terminal 11 comprises, a head portion 19, a tapered portion 21 continuing to the lower face of the head portion 19 and an axial portion 22 protruded downward from the tapered portion 21. The insulating packing 9 comprises, a cylindrical portion 25 having a through hole 24 through which the axial portion 22 of the output terminal 11 penetrates, and a flange 26 lying between the head portion 19 of the output terminal 11 and the lid 7. Before assembled, the tapered portion 21 of the output terminal 11 is so set that the outer diameter on the upper edge side is greater than the inner diameter of the upper edge opening of the through hole 24 of the insulating packing 9 and when caulked by a vertical compression, the outer peripheral face of the tapered portion 21 presses the top edge opening periphery of the through hole 24 of the insulating packing 9 obliquely downward, so that they are adhered firmly in the crushed state.

### BACKGROUND OF THE INVENTION

1. Field of the Invention

The present invention relates to sealed batteries such as lithium ion secondary batteries mounted in small electronic devices.

2. Related Art

According to the following patent documents, sealed batteries disclosed therein have such a configuration that a lid sealing the opening top face of a battery case is provided with a terminal mounting hole formed therethrough, and via an insulating packing and an insulating plate disposed on the front and rear sides of the lid, respectively, an output terminal is caulked and fixed to the terminal mounting hole so as not to be fallen out (the patent documents are: Japanese Utility Model Application Laid-open No. 7-14559 A (paragraphs [0017] to [0020] and FIG. 1), Japanese Patent Application Laid-open No. 7-105919 A (Paragraph [0008] and FIG. 2), Japanese Patent Application Laid-open No. 10-241651 A (Paragraph [0021] and FIG. 1), Japanese Patent Application Laid-open No. 2002-324541 (Paragraph [0004] and FIG. 4), Japanese Patent Application Laid-open No. 2003-45407 A (Paragraph [0010] and FIG. 1), Japanese Patent Application Laid-open No. 2000-208130 A (Paragraphs [0016] to [0017] and FIGS. 1 and 4), and Japanese Patent Application Laid-open No. 2003-272574 A Paragraphs [0020] to [0021] and FIGS. 1 and 4)).

In such cases, when caulked as described above, the head portion of the output terminal is pressed onto the top face of the insulating packing, whereby the insulating packing adheres firmly to the head portion of the output terminal and to the top face of the lid, so that the gap between the output terminal and the lid is sealed by the insulating packing. This keeps gastight and liquid tight conditions and also insulates them electrically.

Such sealed batteries are required to increase the battery capacity, as higher performance electronic devices appear. However, the space for accommodating a battery in an electronic device cannot be changed easily, so it is considered to increase the battery capacity by expanding the inner volume of the battery case and enlarging the electrode body in the battery case, while not changing the outer dimensions of the battery.

For example, it was proposed to make an insulating packing attaching the lower face of the head portion of the output terminal to be thinner, and retract the head portion of the output terminal inward of the battery so as to enlarge the vertical dimension of the battery case by the retracted portion.

However, when the insulating packing is thinned, there arises a problem that the sealing properties provided by the insulating packing between the output terminal and the lid are degraded since the strength of the insulating packing is reduced so that the insulating packing may be broken when caulked, or may be cracked.

### SUMMARY OF THE INVENTION

It is therefore an object of the present invention to provide sealed batteries capable of increasing the battery capacity while ensuring sealing properties provided by insulating packing.

According to a first aspect of the present invention, there is provided as shown in FIGS. 1 and 4, a sealed battery which comprises, a battery case 1 provided with inside battery material (not shown), a lid 7 for closing the opening top face of the battery case 1, provided with a terminal mounting hole 13 therethrough, and an output terminal 11 engaging with the terminal mounting hole 13 via an insulating packing 9

wherein the output terminal 11 comprises, a head portion 19 exposed on the top face of the lid 7, a tapered portion 21 continuing to the lower face of the head portion 19 and being formed to be a tapered peripheral face which is inclined to be diminishing downward, and an axial portion 22 protruded downward from the tapered portion 21; and

the insulating packing 9 comprises, a cylindrical portion 25 having a through hole 24 through which the axial portion 22 of the output terminal 11 penetrates, and a flange 26 provided on the upper edge outer periphery of the cylindrical portion 25 and lies between the head portion 19 of the output terminal 11 and the lid 7.

The battery case 1 may be made of aluminum, stainless, nickel plated aluminum, nickel plated iron, aluminum and nickel clad, or the like. The lid 7 may be formed of a press molding, the material of which may be an aluminum plate, a stainless plate, a nickel plated aluminum plate, a nickel plated iron plate, or the like.

In the free state before assembled, the tapered portion 21 of the output terminal 11 is so set that at least outer diameter on the upper edge side is greater than the inner diameter of the upper edge opening of the through hole 24 of the insulating packing 9. As such, when the output terminal 11 is caulked by a vertical compression, the outer peripheral face of the tapered portion 21 presses the top edge opening periphery of the through hole 24 of the insulating packing 9 obliquely downward, so that they are adhered firmly in the crushed state. Here, the output terminal 11 may be a positive electrode terminal or a negative electrode terminal. The opening periphery of the through hole 24 of the insulating packing 9 may be crushed to be elastically deformed, or may be crushed to be plastically deformed.

The inclination angle θ1 (see FIG. 4) of the tapered portion 21 to the axial portion 22 of the output terminal 11 is preferably 30 to 80 degrees, and more preferably, 40 to 60 degrees. If the inclination angle θ1 becomes smaller than 30 degrees, the force of the tapered portion 21 to press the upper edge opening periphery of the through hole 24 of the insulating packing 9 obliquely downward becomes too small. In contrast, if the inclination angle θ1 becomes greater than 80 degrees, the pressing force is dispersed in a wide range of the insulating packing 9, which degrades the sealing properties.

Between the center of the bottom face of the head portion 19 and the tapered portion 21 of the output terminal 11, a step portion 20 maybe provided. The outer diameter of the step portion 20 may be greater than the inner diameter of the upper edge opening of the terminal mounting hole 13 of the lid 7, and the lower face of the step portion 20 may face the upper face of the opening periphery of the terminal mounting hole 13 via the insulating packing 9.

The upper edge of the outer peripheral face of the cylindrical portion 25 of the insulating packing 9 and the lower face of the flange 26 connect with each other via a sloped portion 28 formed to be a tapered face in which the outer diameter of the outer peripheral face increases upward. In the free state before assembled, the sloped portion 28 may be so set that at least outer diameter on the upper edge side is greater than the inner diameter of the upper edge opening of the terminal mounting hole 13 of the lid 7. With this configuration, when the output terminal 11 is caulked by a vertical compression, the outer peripheral face of the sloped portion 28 of the insulating packing 9 adheres firmly to the upper edge opening periphery of the terminal mounting hole 13 of the lid 7 in a crushed state or deformed state. Here, the sloped portion 28 of the insulating packing 9 may be elastically deformed, or may be plastically deformed into the crushed state.

The inclination angle θ2 (see FIG. 4) of the sloped portion 28 to the cylindrical portion 25 of the insulating packing 9 is preferably 30 to 80 degrees, and more preferably, 40 to 60 degrees. If the inclination angle θ2 becomes smaller than 30 degrees, the force of pressing the upper edge opening periphery of the terminal mounting hole 13 of the lid 7 obliquely downward becomes too small. In contrast, if the inclination angle θ2 becomes greater than 80 degrees, the pressing force is dispersed in a wide range of the insulating packing 9, which degrades the sealing properties.

In the top face of the lid 7, a concave seat 27 with which the flange 26 of the insulating packing 9 engages is formed, and in the state of the output terminal 11 being caulked, it is possible to so set that only the head portion 19 of the output terminal 11 is protruded upward from the lid 7.

(Effects)

According to the present invention, when caulked, the outer peripheral face of the tapered portion 21 of the output terminal 11 presses the upper edge opening periphery of the through hole 24 of the cylindrical portion 25 of the insulating packing 9 obliquely downward, and they strongly adhere locally in the state of crushing the upper edge opening periphery of the through hole 24. Thus, the adhesion portion between the outer peripheral face of the tapered portion 21 and the upper edge opening periphery of the through hole 24 is enhanced. Further, the pressing force also acts in a direction of pushing and expanding the through hole 24, which enhances the adhesion between the outer peripheral face of the cylindrical portion 25 and the terminal mounting hole 13 of the lid 7. Thereby, the high sealing properties between the output terminal 11 and the lid 7 can be maintained

The vertical pressing force when caulked is received by the tapered portion 21 contacting the insulating packing 9 prior to the head portion 19 contacting the insulating packing 9, so that the force is not applied to the part between the bottom face of the head portion 19 and the upper face of the flange 26 of the insulting packing 9. Therefore, even when the vertical thickness of the flange 26 of the insulating packing 9 is reduced, there is no problem of the flange 26 of the insulating packing 9 being broken nor the flange 26 being cracked, when caulked.

Thus, the larger battery capacity can be set by reducing the vertical thickness of the flange 26 of the insulating packing 9, and retracting the head portion 19 of the output terminal 11 inwardly of the battery so as to save the vertical dimension of the battery case 1 relatively large by the retracted portion.

When the step portion 20 is provided to the output terminal 11, the step portion 20 is pressed against the insulating packing 9 prior to the head portion 19 of the output terminal 11 when caulked, whereby high sealing properties between the step portion 20 and the lid 7 can be maintained Further, since the compressive force when caulked is received by the step portion 20, the compressive force is hardly applied to the part between the bottom face of the head portion 19 and the upper face of the flange 26 of the insulating packing 9. Therefore, this aspect is also advantageous for increasing the battery capacity.

When the sloped portion 28 is provided to the insulating packing 9, the sloped portion 28, in the crushed state, presses the upper edge opening periphery of the terminal mounting hole 13 of the lid 7 obliquely downward when caulked, and it adheres firmly to the opening periphery of the terminal mounting hole 13 of the lid 7. Thereby, high sealing properties can be maintained between the insulating packing 9 and the lid 7. Further, the compressive force when caulked is received by the sloped portion 28, whereby the compressive force is hardly applied to the part between the flange 26 and the top face of the lid 7.

Thus, the larger battery capacity can be obtained by reducing the vertical thickness of the flange 26 of the insulating packing 9, retracting the flange 26 inwardly of the lid 7 so as to relatively enlarge the vertical dimension of the battery case 1 and the electrode body by the retracted portion.

With such a configuration that the flange 26 of the insulating packing 9 is engaged with the seat 27 of the lid 7 when caulked, and only the head portion 19 of the output terminal 11 protrudes upward from the lid 7, it is possible to reduce the thickness of the head portion 19 to thereby increase the electrode size, whereby the larger battery capacity can be obtained.

### DESCRIPTION OF THE DRAWINGS

The above and other objectives and features of the present invention will become more apparent from the following description of preferred embodiments thereof with reference to the accompanying drawings throughout which like parts are designated by like reference numerals, and wherein:

FIG. 1 is a longitudinal cross-sectional view showing the sealing structure of a sealed battery according to the present invention;

FIG. 2 is a longitudinal cross-sectional view showing the entire sealed battery;

FIG. 3 is a plan view of the sealed battery; and

FIG. 4 is an exploded longitudinal cross-sectional view of the sealing structure.

### DETAILED DESCRIPTION OF THE PREFERRED EMBODIMENTS

### EXAMPLE 1

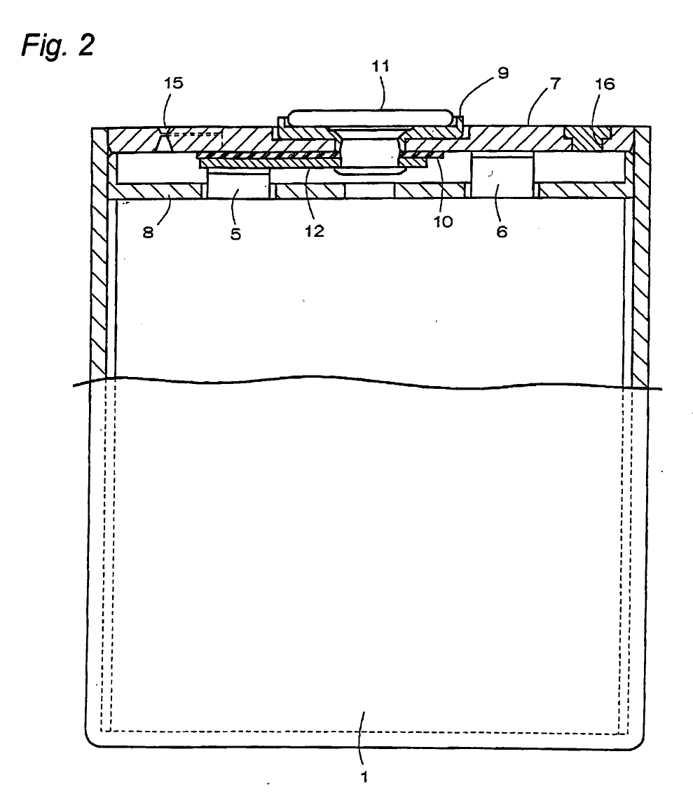

The drawings show an example in which the present invention is applied to a prismatic lithium ion secondary battery. As shown in FIG. 2, there are provided a battery case 1 which is in a bottomed square cylindrical shape having an opening in the top face, an electrode body and a non-aqueous electrolyte solution filled in the battery case 1, and a sealing means for closing the opening top face of the battery case 1. The battery case 1 is formed of an aluminum plate by deep drawing, and also serves as an output terminal of the positive electrode. The dimensions of the battery case 1 is set to be 18 mm in lateral length, 5 mm in longitudinal length, and 20 mm in vertical length.

The electrode body in the battery case 1 includes, a sheet-type positive electrode in which lithium cobalt oxide (LiCoO₂) is used as an active material, a negative electrode in which a carbon material capable of occluding and discharging lithium ion is used as an active maternal, and a separator made of a microporous polyethylene film lying between the positive electrode and the negative electrode, and is formed by being winded spirally and crushed to be flat. From the positive electrode and the negative electrode, conductive tubs 5 and 6 are derived upward, respectively. As the non-aqueous electrolyte solution, a solution prepared by dissolving LiPF₆ in the ratio of 1.0 mol/litter in a solvent prepared by mixing ethylene carbonate (EC) and methyl ethyl carbonate (MEC) in the volume ratio of 1:2, is used.

The sealing means comprises, a rectangle lid 7 for closing the opening top face of the battery case 1, a plastic insulator 8 disposed inside the lid 7, an insulating packing 9, an insulating plate 10 disposed on the inner face side of the lid 7, an output terminal 11 on the negative electrode side (negative electrode terminal) caulked against the lid 7 via the insulating packing 9 and the insulating plate 10, and a metal hold plate 12 disposed under the insulating plate 10.

The lid 7 is a press molding formed of an aluminum plate or the like, and is seal-welded by laser to the upper edge opening periphery of the battery case 1. At the center of the lid 7, a round-shaped terminal mounting hole 13 is formed therethrough, through which the insulating packing 9 and the negative electrode terminal 11 penetrate, as shown in FIG. 4 On the top surface of the lid 7, a concave seat 14 is formed around the terminal mounting hole 13.

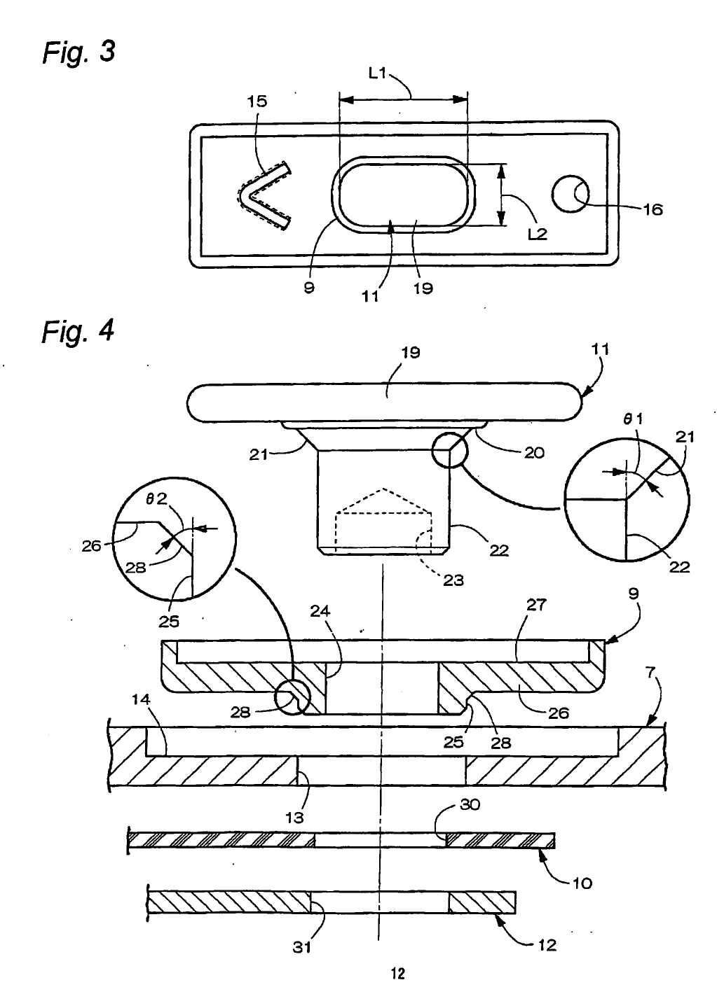

In FIG. 3, one end side in a lateral direction of the lid 7 is provided with a cleaving vent 15 for preventing explosion, and the other end side of the lid 7 is provided with an injection hole 16 for injecting an electrolyte solution. When the inner pressure of the battery case 1 exceeds a certain value, the cleaving vent 15 is broken and evolves a gas in the battery case 1. The injection hole 16 is sealed after an electrolyte solution is injected into the battery case 1.

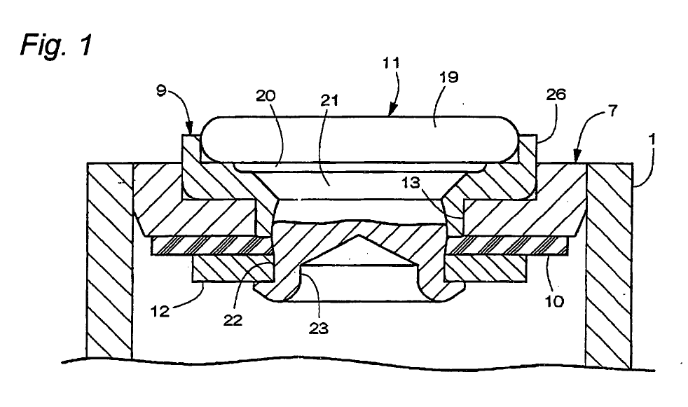

The negative electrode terminal 11 is formed of an iron axis, the surface of which is applied with copper nickel plating. As shown in FIGS. 1 and 4, the negative electrode terminal 11 comprises, a head portion 19 exposed on the top face of the lid 7, a disk-shaped step portion 20 linked to the center of the bottom face of the head portion 19, a cylindrical axial portion 22 protruded downward from the step portion 20 via a tapered portion 21, and a recess 23 formed in the lower edge face of the axial portion 22. The head portion 19 is formed to be ellipse, which is laterally elongated in a plan view. The outer peripheral face of the tapered portion 21 is formed to be a tapered face inclined to be diminishing downward.

The insulating packing 9 is a molding made of a synthetic resin such as polypropylene, fused tetrafluoroethylene perfluoro alkoxy ethylene (PFA), polyethylene terephthalate (PET), or polyphenylene oxide (PPO), which has heat resistance and insulating properties, and can be elastically and plastically deformed slightly. The insulating packing 9 comprises, a cylindrical portion 25 formed in a hollow cylindrical shape which is provided with a through hole 24 through which the axial portion 22 of the negative electrode terminal 11 penetrates, and a laterally elongated ellipse flange 26 which overhangs on the upper edge outer periphery of the cylindrical portion 25 and lies between the head portion 19 of the negative electrode terminal 11 and the lid 7. The upper edge of the outer peripheral face of the cylindrical portion 25 and the lower face of the flange 26 are linked via a sloped face 28. On the upper face of the flange 26, a recess seat 27 is formed with which the lower part of the head portion 19 of the negative electrode terminal 11 is engaged. The outer peripheral face of the sloped face 28 is formed to be a tapered face, in which the outer diameter increases upward.

The insulating packing 9 is formed to have such dimensions that the thickness of the seat 27 at the flange 26 is 0.4 mm, and the thickness of the outer periphery of the flange 26 is 0.6 mm. The inclination angle θ2 of the sloped face 28 to the cylindrical portion 25 of the insulating packing 9 is 45 degrees, as shown in FIG. 4. The thickness of the lid 7 is 0.8 mm. The negative electrode terminal 11 is formed to have such dimensions that the vertical thickness of the head portion 19 is 0.5 mm, and the vertical thickness of the step portion 20 is 0.1 mm. The inclination angle θ1 of the tapered portion 21 to the axial portion 22 of the negative electrode terminal 11 is 45 degrees. The negative electrode terminal 11 is set, when caulked, such that only the head portion 19 is protruded outside in an upward direction from the lid 7.

In FIG. 3, the head portion 19 of the negative electrode terminal 11 is so set that the long diameter L1 in a lateral direction and the short diameter L2 in a longitudinal direction are larger than the inner diameter of the terminal mounting hole 13 of the lid 7, respectively. The outer diameter of the step portion 20 is larger than the inner diameter of the upper end opening of the terminal mounting hole 13 of the lid 7, and the lower face of the step portion 20 faces the upper face of the opening periphery of the terminal mounting hole 13, as shown in FIG. 4.

The outer diameter of the axial portion 25 of the insulating packing 9 is set to be smaller than the inner diameter of the terminal mounting hole 13. In the free state before assembled, the outer diameter on the upper end side of the tapered portion 21 of the negative electrode terminal 11 is set to be larger than the inner diameter of the upper end opening of the through hole 24 of the insulating packing 9.

The insulating plate 10 is, as same as the insulating packing 9, a molding made of a synthetic resin such as polypropylene which has heat resistance and insulating properties, and can be elastically and plastically deformed. As shown in FIG. 4, a packing through hole 30 is formed in the insulating plate 10 therethrough. The hold plate 12 is formed of a metal plate such as a nickel plate in which an axial through hole 31 is formed by punching therethrough.

The inner diameter of the through hole 24 of the insulating packing 9 is set to be almost same size as the outer diameter of the axial portion 22 of the negative electrode terminal 11. The outer diameter of the cylindrical portion 25 of the insulating packing 9 is set to be almost same size as the inner diameter of the terminal mounting hole 13 of the lid 7. The outer diameter of the sloped portion 28, in the free state before assembled, is set so as to be greater than the inner diameter of upper edge opening of the terminal mounting hole 13 in almost every part from the upper edge side to the bottom.

The inner diameter of the packing through hole 30 of the insulating plate 10 is set to be the same size as or a little greater size than the outer diameter of the axial portion 22 of the negative electrode terminal 11. The inner diameter of the axis through hole 31 of the hold plate 12 is set to be a little greater than the outer diameter of the axial portion 22 of the negative electrode terminal 11.

The vertical length of the axial portion 22 of the negative electrode terminal 11 is so set that when the negative electrode terminal 11, the insulating packing 9, the lid 7, the insulating plate 10 and the hold plate 12 are assembled in sequence shown in FIG. 1, the lower end of the axial portion 22 of the negative electrode terminal 11 protrudes downward from the hold plate 12.

More specifically, the insulating plate 10 and the hold plate 12 are disposed to be stacked downwardly in order under the lid 7, and the cylindrical portion 25 of the insulating packing 9 is inserted through the terminal mounting hole 13 of the lid 7 from the upper direction, and the axial portion 22 of the negative electrode terminal 11 is inserted through the through hole 24 of the insulating packing 9 from the upper direction. Here, the lower end of the axial portion 22 of the negative electrode terminal 11 penetrates the pang through hole 30 of the insulating plate 10 and the axis through hole 31 of the hold plate 12, and is protruded downward from the hold plate 12.

When caulked, the head portion 19 of the negative electrode terminal 11 is pressed by a tool and the negative electrode terminal 11 is compressed in a vertical direction, whereby the protruded lower end of the anal portion 22 of the negative electrode terminal 11 is crushed and folded outward, as shown in FIG. 1. Then, in between the lid 7 and the folded part (rivet part) of the lower end of the axial portion 22 of the negative electrode terminal 11, the insulating plate 10 and the hold plate 12 are disposed and fixed. Further, the insulating packing 9 is fixed in between the negative electrode terminal 11 and the terminal mounting hole 13 of the lid 7 so as to integrate the negative electrode terminal 11, the insulating packing 9, the insulating plate 10, and the hold plate 12 with the lid 7.

When caulked as described above, the step portion 20 of the negative electrode terminal 11 is cut into the upper face around the through hole 24 of the insulating packing 9, and the outer peripheral face of the tapered portion 21 of the negative electrode terminal 11 is adhered in the state of inside engagement in which the upper end opening periphery of the through hole 24 of the insulating packing 9 is crushed obliquely downward and deformed. Here, the outer peripheral face of the sloped portion 28 of the insulating packing 9 adherently cuts into the upper end opening periphery of the terminal mounting hole 13 of the lid 7 in the crushed state.

Thereby, the lid 7 and the negative electrode terminal 11 are sealed securely so as to be in the gastight and liquid tight states and are insulated electrically, by the insulating packing 9. Note that the vertical thickness of the flange 26 of the insulating packing 9 and the thickness of the seat 14 of the lid 7 are so adjusted that the lower face of the head portion 19 of the negative electrode terminal 11 is aligned at the almost same height with the top face of the lid 7.

If the vertical thickness of the flange 26 of the insulating packing 9 is too thin, the insulating properties and the strength when caulked are degraded. Therefore, the thickness of the part with the seat 27 of the flange 26 is set to be 0.3 mm or more, and preferably, 0.4 mm or more. Further, if the thickness of the part of the seat 14 part of the lid 7 is thin, it is deformed when caulked and fixed and the sealing properties of the battery are degraded, whereby the thickness is preferably 0.3 mm or more, and more preferably, 0.4 mm or more.

The electrode body was produced as follows. As for the positive electrode, by adding flake graphite as a conductive aid to lithium cobalt oxide as a positive electrode active material in the weight ratio and mixing them, then by mixing the mixture and a solution in which polyvinylidene fluoride was resolved in N-methyl pyrrolidone, a paste was prepared. This paste containing the positive electrode active material was applied in uniform on the both surfaces of a positive electrode collector formed of an aluminum foil strip in 15 μm thickness, and dried, such that a coating film including the positive electrode active material was formed.

In the winding state, a part of the positive electrode collector positioned on the outermost periphery of the positive electrode was not applied with the paste containing the positive electrode active material so that the positive electrode collector was exposed. This strip-shaped positive electrode collector was dried, then calendared, and cut in a prescribed width. Then, the lower end of the aluminum conductive tub 6 of the positive electrode side was welded to the exposed part of the positive electrode collector, whereby a positive electrode was produced.

As for the negative electrode, a graphite carbon material as a negative electrode active material is mixed with a solution in which polyvinylidene fluoride is dissolved in N-methyl pyrrolidone, whereby a paste was prepared. This paste containing the negative electrode active material was applied in uniform on the both surfaces of a negative electrode collector formed of a strip copper foil in the thickness of 10 μm, and dried, such that a coating film containing the negative electrode active material was formed. This strip body was dried, calendared, and cut into a prescribed width. Then, the lower end of the nickel collector lead 5 of the negative electrode was welded to the position coming to the inner peripheral face side of the negative electrode collector in the winding state, whereby a negative electrode was produced Subsequently, the positive electrode and the negative electrode are spirally wound via a separator with a prescribed width, and were crushed to be flat.

When assembling the battery as a whole, first the electrode body and the insulator 8 are mounted in the battery case 1. Next, in the assembly formed by fixig the negative electrode terminal 11 and the like to the lid 7, the collector lead 5 of the negative electrode is welded to the lower face of the hold plate 12, and the collector lead 6 of the positive electrode is welded to the inner face of the lid 7.

Then, the lid 7 is inside engaged on the top end of the battery case 1, and the engagement faces of the lid 7 and the battery case 1 are laser welded and sealed Then, a non-aqueous electrolyte solution is injected into the battery case 1 from the injection hole 16, and the injection hole 16 is sealed Thereby, the battery is completed.

Note that the insulating packing 9 and the insulating plate 10 may be formed of rubber having insulting properties. The head portion 19 of the negative electrode terminal 11 may be selected to be shaped in oval, ellipse, disk, or the like, discretionary. As for the negative electrode terminal 11, the step portion 20 may not be provided between the head portion 19 and the tapered portion 21, and the tapered portion 21 may be provided directly at the center of the lower face of the head portion 19. Further, the insulating packing 9 may not be provided with the sloped portion 28.

Although the battery case 1 and the lid 7 engaged therewith are laterally elongated rectangles in the plan view in the example shown, the short edges on the right and left may be arcs, such that the whole shape thereof may be ellipse. The engaged faces of the lid 7 and the battery case 1 may be sealed by resistance welding or sealed with a synthetic resin adhesive. The outer diameter of the upper end side of the tapered portion 21 of the negative electrode terminal 11 may be greater than the inner diameter of the upper end opening of the through hole 24 of the insulating packing 29 at most parts in a vertical direction.

### EXAMPLE 2

In an example 2, the vertical thickness of the seat 27 of the flange 26 of the insulating packing 9 and the vertical thickness of the seat 14 of the lid 7 are 0.3 mm, respectively, and in the lid 7, the vertical thickness of the parts other than the seat 14 is 0.6 mm. Other aspects are the same as those of the example 1.

### EXAMPLE 3

In an example 3, the thickness of the head portion 19 of the negative electrode terminal 11 is 0.4 mm. Other aspects are the same as those of the example 1.

### EXAMPLE 4

In an example 4, the inclination angle θ1 of the tapered portion 21 to the axial portion 22 of the negative electrode terminal 11 is 60 degrees. Other aspects are the same as those of the example 1.

### EXAMPLE 5

In an example 5, the battery case 1 is set to have such dimensions that the lateral length is 34 mm, the longitudinal length is 5 mm, and the vertical length is 50 mm, and the positive electrode, the negative electrode and the separator are set to have dimensions suitable for the battery case 1. Other aspects are the same as those of the example 1.

### COMPARATIVE EXAMPLE 1

In a comparative example 1, the tapered portion 21 and the step portion 20 are omitted in the negative electrode terminal 11. Other aspects are the same as those of the example 1.

### COMPARATIVE EXAMPLE 2

The tapered portion 21 and the step portion 20 are omitted in the negative electrode terminal 11, and the sloped portion 28 is omitted in the insulating packing 9. Other aspects are the same as those of the example 1.

(Test)

Ten batteries were prepared for each of the examples 1 to 5 and comparative examples 1 and 2, and each battery was stored in a thermostatic chamber for 100 days at the temperature of 60° C. and at the humidity of 90% RH. Then, the change in weight before and after the storage of each battery was measured, and the change in internal resistance before and after the storage of each battery was measured at 1 kHz. Further, constant current discharge was performed at 0.2 C until the voltage of a battery came to 3.0 V or less before and after the storage, and a change in capacity before and after the storage of each battery was measured to thereby calculate the capacity maintenance factor. The results are shown in Table 1. Note that the weight before storage is set to be 100 for the weight change of a battery, and the inner resistance before storage is set to be 100 for the internal resistance of a battery.

TABLE 1

| | Weight | Internal Resistance | Capacity |
|---|---|---|---|
| | Change | Change | Maintenance Rate (%) |
| Example 1 | 100 | 202 | 83 |
| Example 2 | 99.8 | 224 | 81 |
| Example 3 | 100 | 207 | 82 |
| Example 4 | 99.7 | 238 | 80 |
| Example 5 | 99.9 | 195 | 81 |
| Comparative | 97.5 | 321 | 67 |
| Example 1 | | | |
| Comparative | 97.1 | 347 | 64 |
| Example 2 | | | |

As shown in Table 1, in the examples 1 to 5, changes in the inner resistance before and after storage are in a range of 1.95 to 2.38 times. On the other hand, in the comparative examples 1 and 2, changes in the inner resistance before and after storage are 3.2 times or more. Further, in the examples 1 to 5, the capacity maintenance rates before and after storage are 80% to 83%. On the other hand, in the comparative examples 1 and 2, the capacity maintenance rates before and after the storage are 67% or less. Therefore, it is considered that in the comparative examples 1 and 2, the sealing properties were degraded than the examples 1 to 5, such that a leakage of the electrolyte solution or the like might occur.

1. A sealed battery which comprises, a battery case provided with battery materials therein, a lid for dosing the opening top face of the battery case, with a terminal mounting hole, and an output terminal engaging with the terminal mounting hole via an insulating packing;
wherein the output terminal comprises, a head portion exposed on the top face of the lid, a tapered portion continuing to the lower face of the head portion and being formed to be a tapered peripheral face inclined to be diminishing downward, and an axial portion protruded downward from the tapered portion; and the insulating packing comprises, a cylindrical portion having a through hole through which the axial portion of the output terminal penetrates, and a flange provided on the upper edge outer periphery of the cylindrical portion and lies between the head portion of the output terminal and the lid; and
wherein before assembled, the tapered portion of the output terminal is so set that at least outer diameter on the upper edge side is greater than the inner diameter of the upper edge opening of the through hole of the insulating packing and when the output terminal is caulked by a vertical compression, the outer peripheral face of the tapered portion presses the top edge opening periphery of the through hole of the insulating packing obliquely downward, to be adhered firmly in a crushed state or deformed state.

2. The sealed battery according to the claim 1, wherein the inclination angle θ1 of the tapered portion to the axial portion of the output terminal is preferably 30 to 80 degrees, and more preferably, 40 to 60 degrees.

3. The sealed battery according to the claim 1, wherein between the center of the bottom face of the head portion and the tapered portion of the output terminal, a step portion is provided and designed in a way that the outer diameter of the step portion is greater than the inner diameter of the upper edge opening of the terminal mounting hole of the lid, and the lower face of the step portion faces the upper face of the opening periphery of the terminal mounting hole via the insulating packing.

4. The sealed battery according to the claim 1, wherein the upper edge of the outer peripheral face of the cylindrical portion of the insulating packing and the lower face of the flange connect with each other via a sloped portion formed to be a tapered face in which the outer diameter of the outer peripheral face increases upward; and
wherein before assembled, the sloped portion is so set that at least outer diameter on the upper edge side is greater than the inner diameter of the upper edge opening of the terminal mounting hole of the lid and when the output terminal is caulked by a vertical compression, the outer peripheral face of the sloped portion of the insulating packing adheres firmly to the upper edge opening periphery of the terminal mounting hole of the lid in a crushed state or a deformed state.

5. The sealed battery according to the claim 4, wherein the inclination angle θ2 of the sloped portion to the cylindrical portion of the insulating packing is preferably 30 to 80 degrees, and more preferably, 40 to 60 degrees.

6. The sealed battery according to the claim 1, wherein in the top face of the lid, a concave seat is formed to engage with the flange of the insulating packing, and in the state of the output terminal being caulked, only the head portion of the output terminal is protruded upward from the lid.
